(19) United States
(12) Patent Application Publication
(10) Pub. No.: US 2004/0172508 A1
(43) Pub. Date: Sep. 2, 2004

(54) System and method for memory mirroring

(76) Inventors: Vincent Nguyen, Houston, TX (US); Scott T. McFarland, Spring, TX (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/375,379

(22) Filed: Feb. 27, 2003

(51) Int. Cl. G06F 12/16

(52) U.S. Cl. 711/162

(57) ABSTRACT

A memory subsystem implements a mirrored mode and includes a plurality of memory modules coupled to a memory controller. Each module is capable of storing both primary and mirrored data.

### BACKGROUND

As is well known, a computer stores data in memory. In some applications, particularly mission critical applications, it may be desirable to minimize or avoid having any “down time” in which the system is non-operational, such as might happen if memory was to malfunction. As such, various fault tolerant features have been implemented in computer systems. This disclosure relates to an improved memory fault tolerant feature.

### BRIEF SUMMARY

A memory subsystem is disclosed that implements a mirrored mode. The memory subsystem may include a memory controller that may be coupled to a plurality of memory modules over two or more channels. Each module may be capable of storing both primary and mirrored data.

### BRIEF DESCRIPTION OF THE DRAWINGS

For a detailed description of the various embodiments of the invention, reference will now be made to the accompanying drawings in which:

FIG. 1 shows an exemplary host system in which a memory mirrored technique may be employed in accordance with various embodiments of the invention;

FIG. 2 shows a mirroring scheme which avoids the use of quick switches, but has higher performance than channel-to-channel mirroring in accordance with embodiments of the invention;

FIG. 3 further illustrates the operation of the mirroring technique in accordance with embodiments of the invention; and

FIG. 4 shows embodiments of the invention in which buffers may be included to expand the capacity of the memory subsystem.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections. The term “subsystem” as in “memory subsystem” is only intending to be descriptive of one or more embodiments of the invention as usable in conjunction with a host system. The term “central processing unit” (“CPU”) is intended to refer to a processor or any device capable of executing code.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

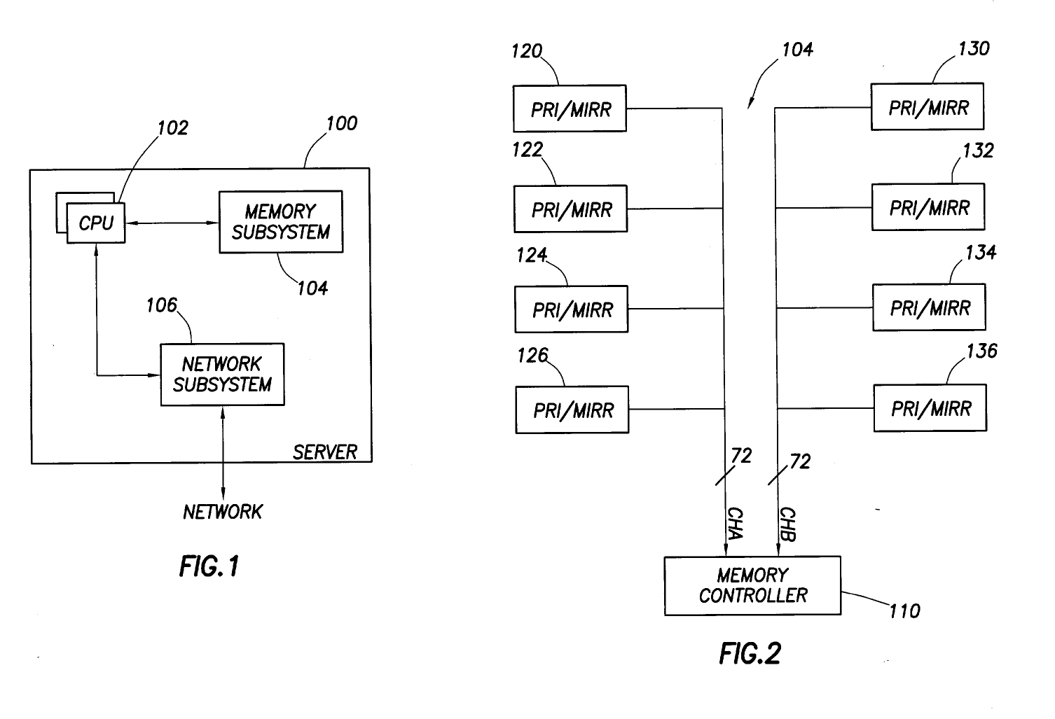

Embodiments of the invention may comprise a memory subsystem which may be usable in a variety of host systems. FIG. 1 shows some embodiments in which a memory subsystem may be included within a host system that comprises a server computer 100. Alternatively, the host could be a non-server computer or any other type of device that includes a memory subsystem. The server 100 of FIG. 1 may include one or more central processing units (“CPUs”) 102 coupled to the memory subsystem 104 of the various embodiments and a network interface 106. Other components may be included in the server 100 as well, and the memory subsystem 104 may be interfaced to other logic in the server 100 in any one of a variety of configurations.

FIG. 2 shows embodiments of memory subsystem 104. As shown, memory subsystem 104 includes a memory controller 110 which provides two channels—CHA and CHB. Channels A and B may be 72 bits wide each as shown or comprise other bit widths. Further, more than two channels may be included. One or more memory modules couple to each channel. As shown, memory modules 120-126 couple to CHA and memory modules 130-136 couple to CHB. Each memory module may comprise a dual in-line memory module (“DIMM”) containing random access memory (“RAM”) or other memory device configurations and technologies.

In accordance with various embodiments of the invention, each memory module 120-136 may be usable to store both primary data and mirrored data in an interleaved configuration. Referring to FIG. 3, as can be seen regarding a conventional memory module 20 used in channel-to-channel mirroring (i.e., mirroring in which each channel contains only primary data or only mirrored data), the module 20 may contain only primary data divided, for purposes of this disclosure, into two portions each designated as P1 and P2. The same may be true with regard to a conventional memory module 30 which may contain only mirrored data and is represented in two portions as M1 and M2. The arrows below the memory modules 20, 30 pointing to modules 120, 130 show conceptually how the data generally may map between the channel-to-channel mirroring of modules 20, 30 and the interleaved scheme described herein. As can be seen, the two halves of the primary data may be mapped to the two modules 120 and 130 as also is the case for the mirrored data halves. As a result, memory module 120 may contain one-half of the primary data and one-half of the mirrored data. Memory module 130 may contain the other one-half of the primary data and the other one-half of the mirrored data.

Referring still to FIG. 3, a feature of the embodiments is that no transistor switches are necessarily needed, as may be the case in some conventional mirroring/hot plug systems. This is because each channel may contain a complete data set. For example, memory module 120 includes both halves of the primary data with one-half being one-half of the primary data and the other half being the mirrored copy of the other half of the primary data. The same may be true with regard to memory module 130. As such, referring to FIG. 2, the data stored in memory modules 120-126 on CHA may represent all of the data, although one-half is primary data and the other half is mirrored data. The data in the memory modules 130-136 associated with CHB similarly also may contain a complete view of all of the data. Thus, CHA can be disabled by memory controller 110 to remove/install memory modules 120-126, and the memory controller may continue operation in a mode which lacks fault tolerance in which the memory modules on CHB may be used in a single memory channel mode (i.e., no mirroring). In this embodiment, the memory controller 110 may be used to isolate the memory modules to be hot removed/installed and thus no quick switches are needed. After the hot remove/insert event has completed, the memory controller 110 may transition back to its preferred fault tolerant, memory interleaved mode as depicted in FIGS. 2 and 3.

Another feature of the memory subsystem 104 is that primary data may be distributed across both channels. Thus, when reading data, primary data can be read concurrently from memory modules on both channels and thus, at least for the exemplary embodiment of FIG. 2, 144 bits of primary data may be read in one cycle. This is in contrast to some channel-to-channel mirroring systems in which a single memory read cycle can return from only one channel as only one channel has primary data.

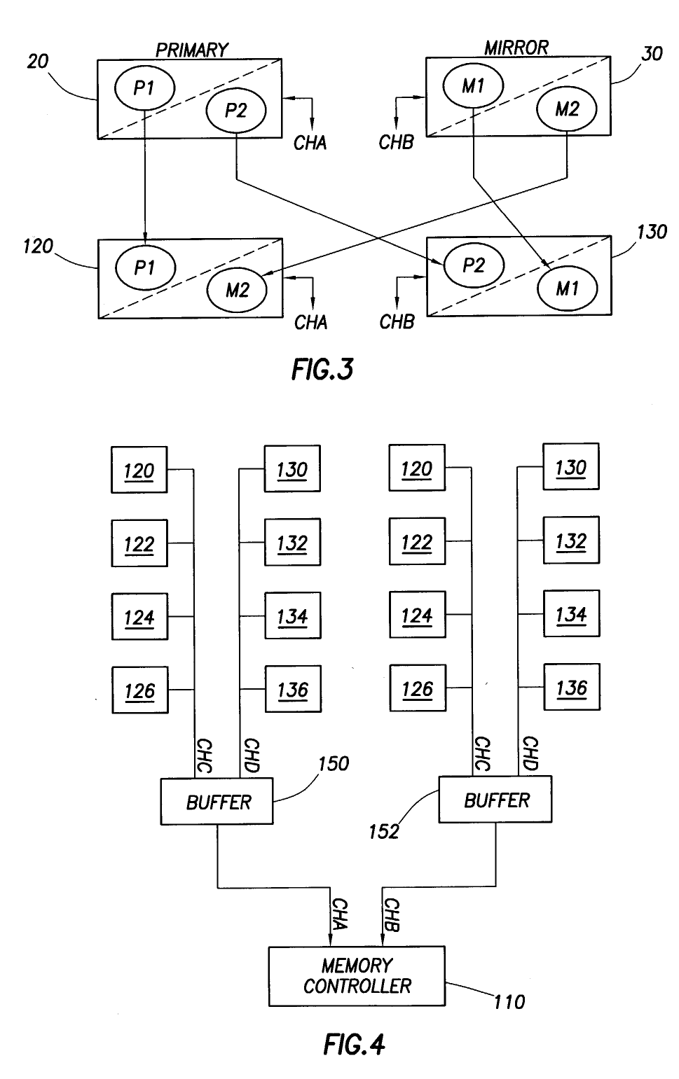

In the embodiments discussed above, eight memory modules are coupled to two channels from the memory controller—four modules per channel. The system can readily be scaled to provide more memory modules. FIG. 4 shows one exemplary embodiment in which the memory controller 110 may couple, via its two channels (CHA and CHB), to two buffers 150, 152. Each buffer 150, 152 in turn provides two channels, CHC and CHD, to various memory modules 120-136 as shown. Thus, twice as many memory modules are permitted in this embodiment as compared to that of FIG. 2. Each buffer 150, 152 contains a plurality of entries in which read/write commands can be stored pending execution on the channels CHC and CHD.

The interleaved mirroring scheme described herein may be extended so as to apply between buffers or within the two channels of an individual buffer. That is, each buffer/channel combination can effectively be a replication in operation of the embodiment of FIG. 2. Alternatively, buffer 150 and its associated modules may represent channel CHA of FIG. 2 and buffer 152 and its modules may represent CHB of FIG. 2. The memory controller can then isolate one of the buffers and its memory modules 120-136. Alternatively, one channel CHC/CHD can be isolated from the other channel pertaining to the same buffer.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer system, comprising:
a CPU; and
a memory subsystem coupled to said CPU, said memory subsystem including a memory controller coupled to a plurality of memory modules over a pair of channels, said memory subsystem providing mirroring in which each memory module contains primary data and mirrored data.

2. The computer system of claim 1 wherein said memory controller can isolate one channel from the other to permit a memory module on a channel to be hot plugged without loss of data in said computer system.

3. The computer system of claim 1 wherein said memory modules couple to said memory controller without the use of switches.

4. The computer system of claim 3 wherein said memory controller is capable of concurrently reading primary data from both channels.

5. The computer system of claim 1 wherein said memory controller can concurrently read primary data from both channels.

6. A memory subsystem, comprising:
a memory controller having at least two channels and providing mirroring;
a plurality of memory modules coupled to each channel wherein at least some of said memory modules are capable of concurrently storing both primary data and mirrored data.

7. The memory subsystem of claim 6 wherein said memory controller can isolate one channel from the other to permit a memory module on a channel to be hot plugged without loss of data in said memory subsystem.

8. The memory subsystem of claim 6 wherein said memory modules couple to said memory controller without the use of switches.

9. The memory subsystem of claim 8 wherein said memory controller can concurrently read primary data from both channels.

10. The memory subsystem of claim 6 wherein said memory controller can concurrently read primary data from both channels.

11. A memory subsystem, comprising:
a memory controller having a first pair of channels and providing mirroring;
a pair of buffers connected to said memory controller via said first pair of channels and containing storage for read and write commands and coupled to said memory controller via said channels; and
a plurality of memory modules coupled to each of said buffers via a second pair of channels, wherein each memory module contains primary data and mirrored data.

12. The memory subsystem of claim 11 wherein said buffer can isolate one of said second pair of channels from the other of said second pair of channels to permit a memory module connected to the isolated channel to be hot plugged without loss of data in said memory subsystem.

13. The memory subsystem of claim 11 wherein said memory controller can isolate one of said first pair of channels from the other of said first pair of channels to permit the memory modules connected to the buffer on the isolated channel to be hot plugged without loss of data in said memory subsystem.

14. The memory subsystem of claim 11 wherein said memory modules couple to said second pair of channels without the use of switches.

15. The memory subsystem of claim 14 wherein said memory controller can concurrently read primary data from memory modules on both of said second pair of channels.

16. The memory subsystem of claim 14 wherein each of said buffers can concurrently read primary data from the memory modules connected to said buffer.

17. The memory subsystem of claim 11 wherein each of said buffers can concurrently read primary data from the memory modules connected to said buffer.

18. A computer system comprising:
a CPU;
a plurality of memory modules coupled over a plurality of channels to said CPU wherein said memory modules are capable of recovering write requests to store data; and
means for mirroring data in which each memory module includes primary data and mirrored data.

19. The computer system of claim 18 wherein said memory modules couple to said channels without switches.

20. A method usable in a system having a plurality of memory modules, comprising:
receiving primary data;
copying said primary data to produce mirrored data; and
writing a portion of the primary data and a portion of the mirrored data to a memory module.

21. The method of claim 20 including writing primary data and mirrored data to a plurality of memory modules.
